(19) United States
(12) Patent Application Publication
(10) Pub. No.: US 2023/0405506 A1
(43) Pub. Date: Dec. 21, 2023

(54) TELESCOPING STACKED FILTER REMOVAL DEVICE

(71) Applicants: Jose Almonte, St. Cloud, FL (US); Maritza A Almonte, St. Cloud, FL (US)

(72) Inventors: Jose Almonte, St. Cloud, FL (US); Maritza A Almonte, St. Cloud, FL (US)

(21) Appl. No.: 17/845,625

(22) Filed: Jun. 21, 2022

(51) Int. Cl. B01D 46/42; F24F 13/28

(52) U.S. Cl. CPC B01D 46/4227; F24F 13/28

(57) ABSTRACT

A stacked filter removal device includes an elongated handle segment having a grip along a proximal end, and an elongated filter engagement segment along a distal end. At least one intermediate segment is telescopically connected to the handle segment and the filter engagement segment to permit the device to transition between an extended orientation and a collapsed orientation. A light, a hook and magnets are positioned along the distal end of the filter engagement segment, and a light switch is located along the handle segment adjacent to a hand grip.

### TECHNICAL FIELD

The present invention relates generally to the commercial HVAC industry, and more particularly to a telescoping tool for removing and installing stacked filters within a commercial air conditioning system.

### BACKGROUND

The statements in this section merely provide background information related to the present disclosure and may not constitute prior art.

Air conditioning units for large buildings and commercial spaces often range between 25- and 100-Ton units. Owing to the large size and airflow produced by these units, it is necessary to utilize multiple primary filters which function to remove impurities such as dust and bacteria from flowing through the system. As shown best at Background FIG. 1, many large A/C units 1 have a plurality of shelves 3a, and 3b, which may be aligned vertically and/or horizontally. The shelves are typically positioned between the hood/damper 2 and the heat exchanger 4, and function to hold the filters 5 so the air reaching the fan 6 is clean.

As shown, each shelf can function to receive a plurality of individual filters 5 which are slid/stacked (see arrow a) along the shelves so as to extend from one side of the unit to the other. In some instances, the filters 5 may be constructed from a rugged metal housing having a fabric or metallic screen for performing the air filtration. These filters are entirely or partially reusable, and care must be taken to ensure they are not damaged when being removed for cleaning. In other instances, disposable filters are used. Such filters are typically constructed from a cardboard housing with a fabric filter element. Although these filters cannot be reused, care must be taken when removing them from the A/C unit, as they have a tendency to rip or disintegrate, thus leaving behind debris which can damage or fowl the downstream components.

Regardless of the type of filter used, and depending on the tonnage of the unit, it is not uncommon for between 4 and 8 individual filters to be positioned serially along each individual shelf. Unfortunately, access to the shelves is typically only provided along one side of the A/C body, which means reaching and removing the filters on the far ends of the shelves is difficult. In many instances, workers must literally crawl into the tight space between the shelf and the damper to grasp and gently pull the used filters out of the unit. Such work is difficult, time consuming and potentially dangerous.

Accordingly, it would be beneficial to provide a stacked filter removal tool which can be used by a technician to access and remove hard to reach stacked filters from A/C units so as to overcome the drawbacks noted above.

### SUMMARY OF THE INVENTION

The present invention is directed to a stacked filter removal device. One embodiment of the present invention can include an elongated handle segment having a grip along a proximal end, and an elongated filter engagement segment along a distal end. At least one and preferably two intermediate segments can be telescopically connected to the handle segment and the filter engagement segment to permit the device to transition between an extended orientation and a collapsed orientation.

In one embodiment, a hook can be positioned along the distal end of the filter engagement segment. The hook preferably having a generally L-shape so as to position the distal portion of the hook approximately 1.5 inches from the body portion of the filter engagement segment. Such dimensions being suitable for engaging the sides of most commercially available air conditioning filters used with stacked configuration units.

In one embodiment, magnetic elements can be disposed along the filter engagement segment for engaging metallic filters. A light can be positioned within or along the filter engagement segment and can be controlled by a switch located along the handle segment.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a side view of an air conditioning unit with a stacked filter configuration in accordance with the background art that is useful for understanding the inventive concepts disclosed herein.

FIG. 2 is a side view of the telescoping stacked filter removal device in the expanded orientation, in accordance with one embodiment of the invention.

FIG. 3 is a side view of the telescoping stacked filter removal device in the collapsed orientation, in accordance with one embodiment of the invention.

FIG. 4 is a perspective view of the telescoping stacked filter removal device in operation, in accordance with one embodiment of the invention.

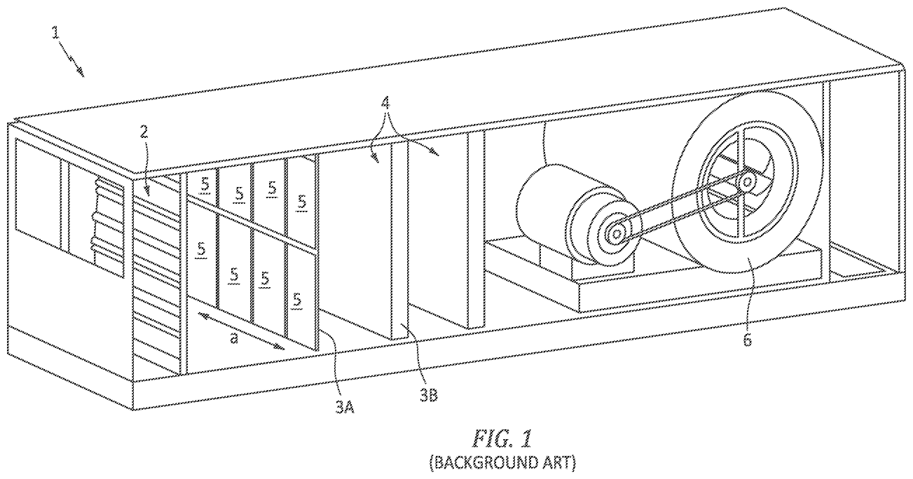

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described throughout this document, the term “about” “approximately” “substantially” and “generally” shall be used interchangeably to describe a feature, shape or measurement of a component within a tolerance such as, for example, manufacturing tolerances, measurement tolerances or the like.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “slidingly positioned”, “telescopically connected” and derivatives thereof shall be used interchangeably to describe a situation wherein two identified objects are connected linearly such that one identified part slides into and out from the other identified part so as to selectively lengthen or shorten the combined total linear length of both parts.

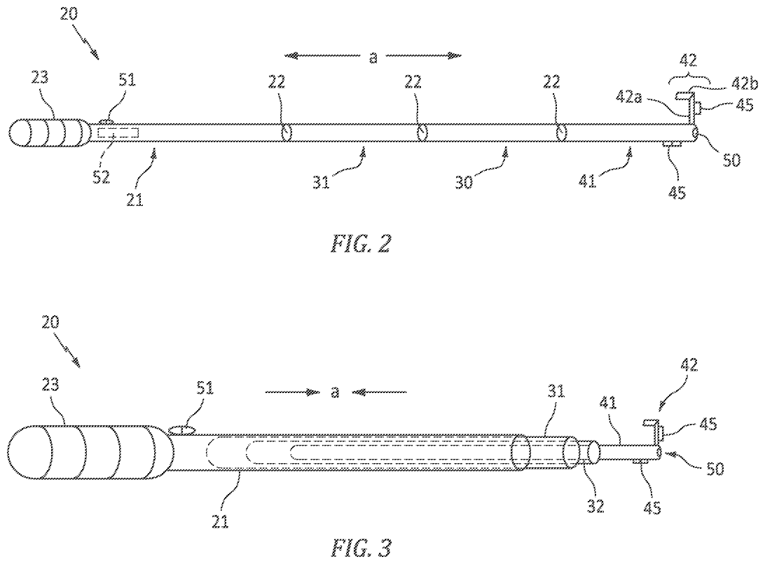

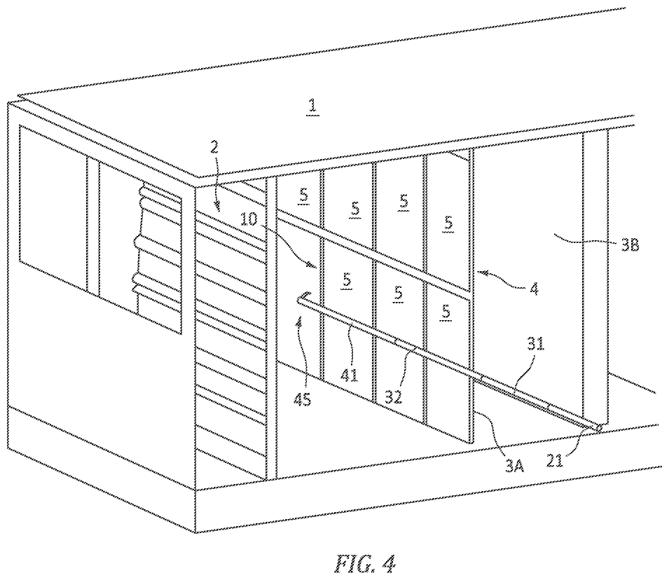

FIGS. 2-4 illustrate one embodiment of a telescoping stacked filter removal device in the expanded and contracted positions. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

As shown in the drawings, the device 20 can comprise a telescoping handheld pole having a handle segment 21 along a first end and a filter engagement segment 41 along a distal end. In the preferred embodiment, the pole can include two intervening segments 31 and 32 positioned between the handle segment and filter engagement segment.

In one embodiment, each of the segments can comprise elongated hollow tubular members having an opening along one end for slidingly receiving an adjacent segment. More specifically, the filter engagement segment 41 can be slidingly positioned within intervening segment 32, which itself can be slidingly positioned within intervening segment 31 which is slidingly positioned within handle segment 21.

As shown by arrow a, each segment can be individually lengthened and shortened in order to increase or decrease the total length of the pole. Additionally, telescoping tube clamps 22 can be provided along the opening of each segment in order to allow a user to selectively secure each segment at a specified length.

As described herein, each of the pole segments 21, 31, 32 and 41 may be formed from materials that are, for example, relatively strong and stiff for their weight. Several nonlimiting examples include but are not limited to various metals or metal alloys (e.g., aluminum, or alloys thereof), plastic/polymers (e.g., high-density polyethylene (HDPE), rigid polyvinyl chloride (PVC), or polyethylene terephthalate (PET)), and/or various composite materials (e.g., carbon fibers in a polymer matrix, fiberglass, etc.).

Although described above with regard to the device including a particular number of segments, specific shapes, sizes or construction materials, this is for illustrative purposes only. To this end, other embodiments having a different number of segments, shapes, sizes and/or construction materials are also contemplated.

In one embodiment, a grip 23 can be positioned along one end of the handle segment 21. The grip preferably being constructed from a rubberized material to provide increased friction with the hand of a user operating the device. Of course, any number of other construction materials are also contemplated.

In one embodiment, a generally L-shaped retrieval hook 42 can be provided along the distal end of the filter engagement segment 41. As shown, the retrieval hook can preferably include a proximal hook section 42a that extends perpendicularly outward from the filter engagement segment 41, and a distal hook section 42b that extends toward the handle segment 21 at a parallel orientation to the filter engagement segment.

Owing to the delicate nature of air filters to be engaged by the hook, it is preferred that the proximal hook section include a length of 1.5 inches, so as to allow a user to position the distal section of the hook behind a filter being retrieved. Such a dimension being important so as to allow the device to function with 99% of all commercially manufactured metallic or disposable air filters which are typically manufactured to include a depth of between 0.5 and 1.25 inches. Moreover, such a feature is important as this allows the hook to engage the filter from the side, rather than making contact with the filter screen which can become ripped or damaged if such a contact is made.

In one embodiment, one or more magnets 45 can be positioned along the hook 42 and/or a portion of the filter engagement segment 41. The magnets can function to allow the device to selectively engage metallic filters and remove the same utilizing minimal contact by the device.

In one embodiment, a light 50 can be positioned along the filter engagement segment 41. The light can preferably comprise a Light Emitting Diode that is electrically connected to a switch 51 and onboard battery 52 for providing control and power thereto. Of course, any number of other types of lights are contemplated, and the switch and/or battery can be located at other positions along the device.

In operation, the light can function to assist the user in positioning the hook of the filter engagement segment within the A/C unit 1 at a location adjacent to the end of a stacked filter 5 to be removed. Once positioned, the user can manipulate the device to position the filter between the proximal and distal sections of the hook 42 and/or can position the magnets 45 adjacent to the filter. When so positioned, the user can simply pull (see arrow b) the filter out of the unit without causing damage to the filter or having to crawl inside the cramped space of the A/C housing 1.

Although dimensions are not critical, in the preferred embodiment, the device 20 will be constructed so as to include a total length in the expanded orientation of between 5½ and up to 10 feet, in order to accommodate varying sized A/C units. Of course, other embodiments having different lengths are also contemplated.

As described herein, one or more elements of the telescoping stacked filter removal device 20 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A stacked filter removal device, said device comprising:
at least one intermediate segment having a first end and a second end;
a handle segment that is telescopically connected to the first end of the at least one intermediate segment;
a filter engagement segment that is telescopically connected to the second end of the at least one intermediate segment; and
a hook that is positioned along a distal end of the filter engagement segment, wherein the handle segment the filter engagement segment and the at least one intermediate segment are configured to transition between an expanded position and a contracted position, and wherein the hook is configured to engage an air conditioning filter.

2. The device of claim 1, further comprising:
a light that is positioned along the filter engagement segment.

3. The device of claim 2, wherein the light comprises a light emitting diode that is positioned along a distal end of the filter engagement segment.

4. The device of claim 3, further comprising:
a switch that is positioned along the handle segment.

5. The device of claim 4, further comprising:
a battery that is positioned within the handle segment.

6. The device of claim 5, wherein each of the battery and the switch are in electrical communication with the light.

7. The device of claim 1, further comprising:
a grip that is positioned along a proximal end of the handle segment.

8. The device of claim 1, wherein the at least one intermediate segment comprises a first intermediate segment and a second intermediate segment.

9. The device of claim 8, wherein the handle segment is connected to the first intermediate segment, and the filter engagement segment is connected to the second intermediate segment.

10. The device of claim 1, wherein in the expanded position the device includes a length of approximately five feet and six inches.

11. The device of claim 1, wherein each of the handle segment, the filter engagement segment and the at least one intermediate segment are constructed from plastic.
